(19) United States
(12) Patent Application Publication
(10) Pub. No.: US 2025/0286284 A1
(43) Pub. Date: Sep. 11, 2025

(54) REDUCED ELEMENT COUNT IN RECONFIGURABLE INTELLIGENT SURFACES WITHOUT COMPROMISING ARRAY GAIN

(71) Applicant: Dell Products L.P., Round Rock, TX (US)

(72) Inventors: Tejinder Singh, Kanata (CA); Kan Wang, Ottawa (CA); Navjot Kaur Khaira, Kanata (CA)

(21) Appl. No.: 18/599,446

(22) Filed: Mar. 8, 2024

(51) Int. Cl. H01Q 15/00

(52) U.S. Cl. CPC H01Q 15/0066

(57) ABSTRACT

The technology described herein is directed towards designing and implementing a reconfigurable intelligent surface with a modified triangular grid structure arrangement that results in a sparser arrangement of unit-cells, and thereby reduces the cost and power requirements of the reconfigurable intelligent surface. The modified triangular grid structure surpasses the conventional half-wavelength spacing constraint of existing reconfigurable intelligent surfaces, while effectively avoiding grating lobes, and has only a very low reduction in gain. The vertical spacing of elements is determined based on the reconfigurable intelligent surface's operating frequency/wavelength; the horizontal spacing is based on the vertical spacing and a defined grid angle. The horizontal spacing of the elements is larger than the vertical spacing of the elements to form a triangular modified grid structure that increases sparsity of the elements by reducing element count per surface area of the reconfigurable intelligent surface, relative to a rectangular grid of elements.

### BACKGROUND

Reconfigurable intelligent surfaces, sometimes referred to as metasurfaces, redirect (e.g., reflect or refract) incoming electromagnetic beams in a fixed direction, by modifying the resultant beams in terms of phase, amplitude, and polarization such as by adjusting signal reflection, absorption, and transmission. As such, reconfigurable surfaces are being investigated for use in the millimeter wave (mmWave) spectrum, where reflected beams can avoid obstacles that otherwise block a signal between a transmitter (e.g., a base station) and a receiver (e.g., a user equipment).

Current reconfigurable intelligent surface technology faces challenges related to cost and power consumption, primarily resulting from the need for a relatively massive number of elements (unit cells) and associated electrical components to achieve the desired functionality. The deployment of such extensive arrays of elements results in high manufacturing costs and complex integration processes. Additionally, the large number of electrical components, such as PIN diodes and varactor diodes, contributes to heightened power consumption, limiting the efficiency and sustainability of such systems.

### BRIEF DESCRIPTION OF THE DRAWINGS

The technology described herein is illustrated by way of example and not limited in the accompanying figures in which like reference numerals indicate similar elements and in which:

FIG. 1 is a block diagram showing an example system for determining element spacing for a reconfigurable intelligent surface with a modified triangular grid structure for element (unit cell) layout, in accordance with various embodiments and implementations of the subject disclosure.

FIG. 2 is a representation of an example grid structure corresponding to a modified triangular grid structure for unit cell layout, in accordance with various embodiments and implementations of the subject disclosure.

FIG. 3 is a representation of an example circle diagram for evaluating geometry related to radiation propagation of propagation modes of interest, in accordance with various embodiments and implementations of the subject disclosure.

FIG. 4 is an example representation of a conventional square grid of elements evaluated via a counting window, in accordance with various embodiments and implementations of the subject disclosure.

FIG. 5 is an example representation of a modified triangular grid of elements evaluated via the counting window, showing a sparser distribution of unit-cells relative to FIG. 4, in accordance with various embodiments and implementations of the subject disclosure.

FIG. 6 is an example representation of a conventional square grid of elements overlaid with a modified triangular grid of elements, for visualizing the sparser distribution of unit-cells in the modified triangular grid of elements relative to the conventional square grid distribution, in accordance with various embodiments and implementations of the subject disclosure.

FIG. 7 is an example representation of a modified triangular grid of elements having a different grid angle relative to FIG. 5, showing a different grid angle and distribution of unit-cells relative to FIG. 5, in accordance with various embodiments and implementations of the subject disclosure.

FIG. 8 is a flow diagram showing example operations related to configuring a reconfigurable intelligent surface with a grid of elements via an increased element spacing distance in one dimension based on a selected grid angle, in accordance with various embodiments and implementations of the subject disclosure.

FIG. 9 is a flow diagram showing example operations related to configuring a reconfigurable intelligent surface for usage based on deriving a grid pattern via a grid angle and a wavelength-determined vertical separation distance, in accordance with various embodiments and implementations of the subject disclosure.

FIG. 10 is a flow diagram showing example operations related to deploying a reconfigurable intelligent surface with a grid pattern of elements that is based on determining a vertical spacing of the elements from an operating frequency, and determining the horizontal spacing of the elements based on a grid angle, in accordance with various embodiments and implementations of the subject disclosure.

FIG. 11 is a block diagram representing an example computing environment into which embodiments of the subject matter described herein may be incorporated.

FIG. 12 depicts an example schematic block diagram of a computing environment with which the disclosed subject matter can interact/be implemented at least in part, in accordance with various embodiments and implementations of the subject disclosure.

### DETAILED DESCRIPTION

Various aspects of the technology described herein are generally directed towards designing and implementing a reconfigurable intelligent surface (metasurface) with a grid arrangement that reduces the cost and power requirements of the reconfigurable intelligent surface by adopting a sparser arrangement of unit-cells. The grid arrangement described herein, referred to herein as a modified triangular grid structure, surpasses the conventional half-wavelength spacing constraint of existing reconfigurable intelligent surfaces, while effectively avoiding grating lobes. Further, the reduction in gain is significantly lower when compared to a straightforward reduction in panel size. The modified triangular grid structure is frequency-independent, and can be applied to any reconfigurable intelligent surface where per-unit-cell based electronic tuning is desired.

Via the sparser arrangement of unit-cell on a reconfigurable intelligent surface resulting from the modified triangular grid structure, benefits include significantly reducing the manufacturing costs, with nearly minimal performance degradation and a corresponding reduction in power consumption of active components. This is accomplished while avoiding unwanted grating lobes throughout the scanning range, without any need of lobe suppression techniques. The technology described herein is very straightforward compared to other sparse array methods, based on design expressions that can be applied directly to new or currently in-flight reconfigurable intelligent surface designs, and thereby can be applied directly to metasurface designs, or for better optimizing a currently-tweaked metasurface. The technology can be applied additively (as a supplement) to other existing cost reduction methods to augment their cost reduction.

It should be understood that any of the examples and/or descriptions herein are non-limiting. Thus, any of the embodiments, example embodiments, concepts, structures, functionalities or examples described herein are non-limiting, and the technology may be used in various ways that provide benefits and advantages in communications and reconfigurable intelligent surfaces in general.

Reference throughout this specification to “one embodiment,” “an embodiment,” “one implementation,” “an implementation,” etc. means that a particular feature, structure, characteristic and/or attribute described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, characteristics and/or attributes may be combined in any suitable manner in one or more embodiments/implementations. Repetitive description of like elements employed in respective embodiments may be omitted for sake of brevity.

The detailed description is merely illustrative and is not intended to limit embodiments and/or application or uses of embodiments. Furthermore, there is no intention to be bound by any expressed or implied information presented in the preceding sections, or in the Detailed Description section. Further, it is to be understood that the present disclosure will be described in terms of a given illustrative architecture; however, other architectures, structures, materials and process features, and steps can be varied within the scope of the present disclosure.

It also should be noted that terms used herein, such as “optimize,” “optimization,” “optimal,” “optimally” and the like only represent objectives to move towards a more optimal state, rather than necessarily obtaining ideal results. For example, “optimal” placement of a subnet means selecting a more optimal subnet over another option, rather than necessarily achieving an optimal result. Similarly, “maximize” means moving towards a maximal state (e.g., up to some processing capacity limit), not necessarily achieving such a state, and so on.

It will also be understood that when an element such as a layer, region or substrate is referred to as being “on” or “over” “atop” “above” “beneath” “below” and so forth with respect to another element, it can be directly on the other element or intervening elements can also be present. In contrast, only if and when an element is referred to as being “directly on” or “directly over” another element, are there no intervening element(s) present. Note that orientation is generally relative; e.g., “on” or “over” can be flipped, and if so, can be considered unchanged, even if technically appearing to be under or below/beneath when represented in a flipped orientation. It will also be understood that when an element is referred to as being “connected” or “coupled” to another element, it can be directly connected or coupled to the other element or intervening elements can be present. In contrast, only if and when an element is referred to as being “directly connected” or “directly coupled” to another element, are there no intervening element(s) present.

The following detailed description is merely illustrative and is not intended to limit embodiments and/or application or uses of embodiments. Furthermore, there is no intention to be bound by any expressed or implied information presented in the preceding sections, or in the Detailed Description section.

One or more example embodiments are now described with reference to the drawings, in which example components, graphs and/or operations are shown, and in which like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details, and that the subject disclosure may be embodied in many different forms and should not be construed as limited to the examples set forth herein.

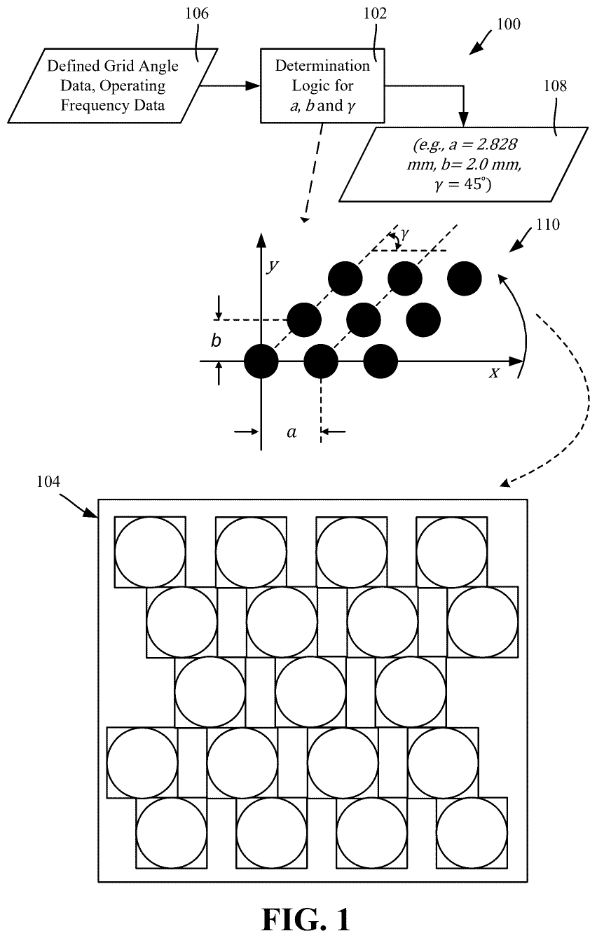

FIG. 1 shows a generalized block diagram of an example system 100 including determination logic 102 for implementing a reconfigurable intelligent surface 104 (a reflective or refractive metasurface) with a modified triangular grid pattern of elements, where elements are also referred to herein as unit cells. As described herein, given input data 106 such as a defined grid angle and intended operating frequency of the reconfigurable intelligent surface 104, the determination logic 102 operates to determine periodicity data (a, b) of a modified triangular grid of radiating elements that are part of the surface 104. As described herein, the modified triangular grid is based on a grid angle of γ, which can be defined based on acceptable specular loss, dependent on ground exposure ratio data of a design of the elements. In other words, as will be understood the modified grid structure results in a sparser array with fewer unit cells exposed to the incident wave, whereby consideration needs to be given to the effect caused by the higher ground exposure ratio as a result of the sparser array. This can be estimated by the specular reflection effect from ground panel exposure ratio (GPER), to verify that a selected grid angle of γ does not significantly compromise the array gain for a given design.

Thus, the determination logic can determine the value of b for the periodicity data (a, b) based on the wavelength data that corresponds to the operating frequency, e.g., the half-wavelength distance. Once the grid angle γ is defined, given the value of b and the grid angle γ, as described herein the determination logic 102 further determines the value of a for the periodicity data (a, b), which determines the relative positions for the elements (block 108, corresponding to the geometrically arranged black dots in the annotated graph 110), in that (as will be understood) the elements align along the grid angle.

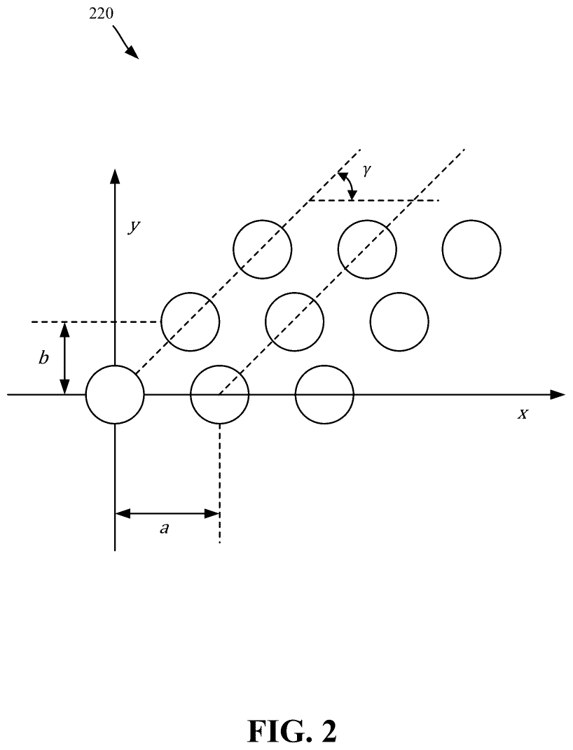

Described herein with reference to FIGS. 2-7 is a technology including a procedure for designing and implementing a modified triangular grid structure that results in a metasurface with a sparser number of unit cells (compared to a square grid structure metasurface). In the context of reconfigurable intelligent surfaces, which involves periodic structures, Floquet analysis enables the study of wave propagation and scattering phenomena. Floquet analysis aids in understanding the dispersion characteristics, eigenmodes, and the impact of the periodic structure on the overall performance of a reconfigurable intelligent surface. Notably, the abstract nature of Floquet analysis means that its conclusions are independent of specific technologies or intricate geometries, relying only on a few assumptions such as periodicity and grid angle.

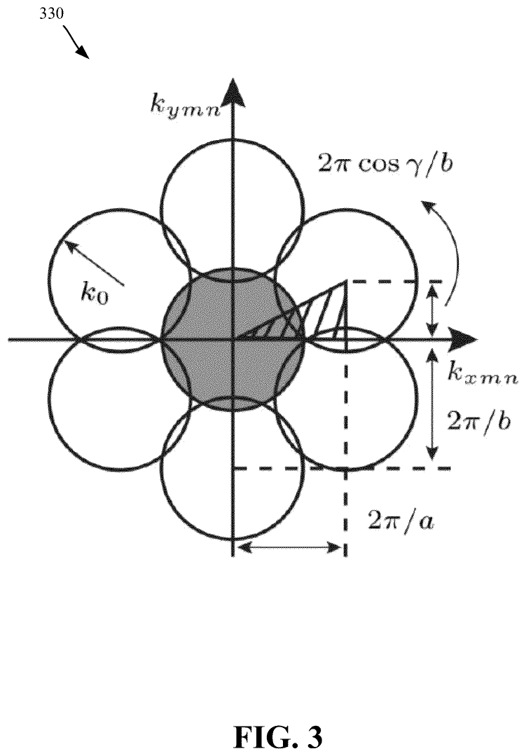

A first part of the technology described herein is directed to deriving grating lobe locations in a grid structure using Floquet analysis. To this end, FIG. 2 depicts part of a modified triangular grid structure 220 (corresponding to the annotated graph 110 of FIG. 1) for unit cell layout, and FIG. 3 depicts a circle diagram 330 representing condition of propagation for any mode of interest.

In general, a reconfigurable intelligent surface comprises of an array of identical radiating elements; such a grid depicting the centers of the radiating elements, as the centers of the unshaded circles, is shown in FIG. 2. The grid points are defined as:

$${x}_{mn} = ma + \frac{nb}{tan γ} \\ {y}_{mn} = nb \qquad ( 1 )$$

where, m, n refers to the element number on the grid, a,b refers to the horizontal and vertical element spacing, and γ refers to the grid angle in what will be referred to herein as a modified triangular grid.

FIG. 3 is an example circle diagram representation accounting for the grid angle (γ); (e.g., as a variable within 2π cos γ/b). Each circle indicates a different mode, and the grey circle in the center indicates the propagation mode.

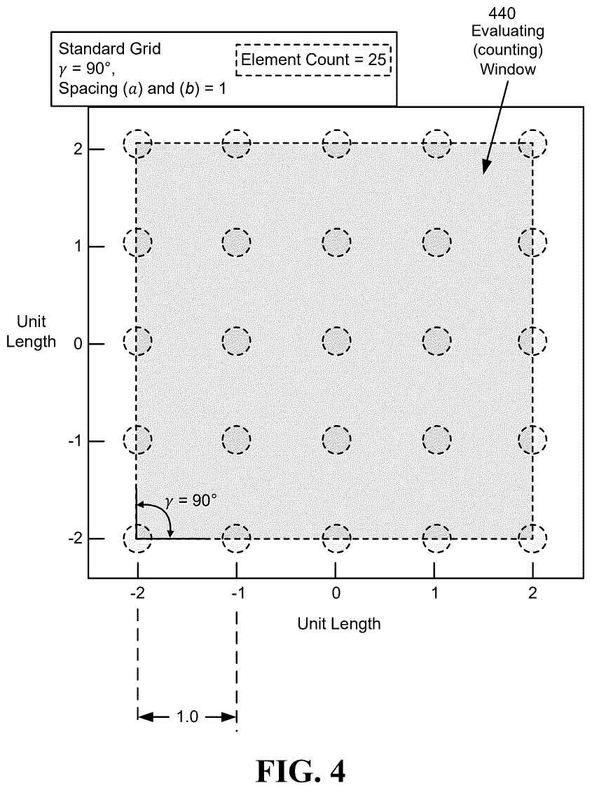

The Floquet series of the surface current on the general grid structure with a two-dimensional Floquet excitation and some basic properties is represented in Equations (2) and (3):

$$\vec{I} ( x , y ) = \hat{y} \frac{4 {π}^{2}}{ab} {\sum }_{m} {\sum }_{n} \tilde{f} ( {k}_{xmn} , {k}_{ymn} ) exp ( - {jk}_{xmn} x - {jk}_{ymn} y ) \qquad ( 2 )$$

$${k}_{xmn} = {k}_{x 0} + \frac{2 m π}{a} \\ {k}_{ymn} = {k}_{y 0} + \frac{2 n π}{b} - \frac{2 m π}{a tan γ} \qquad ( 3 )$$

where x, y, a, b, γ are grid parameters, and can be seen from the representation of the general grid structure in FIG. 2. Two constants kₓₘₙ and k_{ymn} determine the phase shift between the adjacent cells. In the derivation of a rectangular grid structure (e.g., FIG. 4), the grid angle γ is set to 90° and xₘₙ=ma, yₘₙ=nb. The (m, n) terms are associated with T M_{ymn} Floquet mode, where (0, 0) Floquet mode is considered as the fundamental mode.

The corresponding radiation angles in the spherical coordinate system are defined by:

$${k}_{xmn} = {k}_{0} sin {θ}_{m n} cos {ϕ}_{mn} \qquad ( 4 )$$

$${k}_{ymn} = {k}_{0} sin {θ}_{m n} sin {ϕ}_{mn} \qquad ( 5 )$$

$${k}_{zmn} = {k}_{0} cos {ϕ}_{mn} \qquad ( 6 )$$

where θ is the elevation angle and ϕ is the azimuth angle in spherical coordinates.

A Floquet mode becomes a propagation plane wave only if the following condition is satisfied:

$${k}_{xmn}^{2} + {k}_{ymn}^{2} \leq {k}_{0}^{2} \qquad ( 7 )$$

Combining the above equations using γ=90° gives a family of circular regions as shown in FIG. 3, for a reconfigurable intelligent surface designed with a conventional square grid (e.g., FIG. 4):

$${( {k}_{xmn} - \frac{2 m π}{a} )}^{2} + {( {k}_{ymn} - \frac{2 n π}{b} )}^{2} = {k}_{0}^{2} sin {θ}_{0}^{2} \qquad ( 8 )$$

Embodiments of the technology described herein relate to deriving the (e.g., maximum) element spacing in a triangular modified grid structure as a function of continuous grid angle, based on the circle diagram as shown in the FIG. 3. Note that derivations for the triangular modified grid structure are only known to be available for an equilateral triangular case, rather than alternative structures as described herein and associated performance characteristics.

For a modified grid structure with arbitrary grid angle γ, equation (3) is used. Substituting equation (3) into the propagation condition of equation (7), indicated by the grey area in the FIG. 3, gives:

$${( {k}_{x} - \frac{2 m π}{a} )}^{2} + {( {k}_{y} - \frac{2 n π}{b} + \frac{2 m π}{a tan γ} )}^{2} \leq {k}_{0}^{2} \qquad ( 9 )$$

The maximum scan angle, is given by:

$${k}_{0} sin {θ}_{ma x} = \frac{2 π}{b} - {k}_{0} \qquad ( 10 )$$

where, θ is defined in Equation (4) to be the angle between the beam direction and z-axis normal to the surface; b is assumed to be smaller than a for simplicity. In case of b>a, the grid angle γ′=90°−γ can be defined to revert to the described examples. Note that what are considered horizontal (one dimension) and vertical (another, perpendicular dimension) are relative and only used in the examples, and indeed the designs can be rotated in any of these two x- and y-dimensions without changing the resulting pattern.

To ensure a symmetrical scanning region, the circle center of the adjacent higher order modes to the propagation mode circle has to be symmetrically located. This is given by the geometric relationship of the dashed triangle in FIG. 3:

$${( \frac{2 π}{b} )}^{2} = {( \frac{2 π}{a} )}^{2} + {( \frac{2 π cos γ}{b} )}^{2} \qquad ( 11 )$$

The maximum element spacing a in the modified grid structure is obtained by substituting a from Equation (11) to Equation (10) as:

$$a = \frac{{λ}_{0}}{1 + sin {θ}_{m ax}} * \frac{1}{sin γ} \qquad ( 12 )$$

With θ=90° and γ=90° as the maximum gain beam angle of the conventional rectangular grid structure, the classic half-wavelength spacing is obtained as a=b=λ/2. With θ=90° and γ=60°, the above expression yield

$$a = \frac{λ}{2} * \frac{1}{sin ( 60 )} ≅ 1.15 λ / 2 ,$$

agreeing with the derivation for an equilateral triangular grid, confirming equation (12).

Turning to an example in which γ=45°, the obtained maximum element spacing facilitates cost reduction in reconfigurable intelligent surfaces. In general, this involves organizing unit-cells with greater sparsity, surpassing the conventional half-wavelength constraint while circumventing grating lobes.

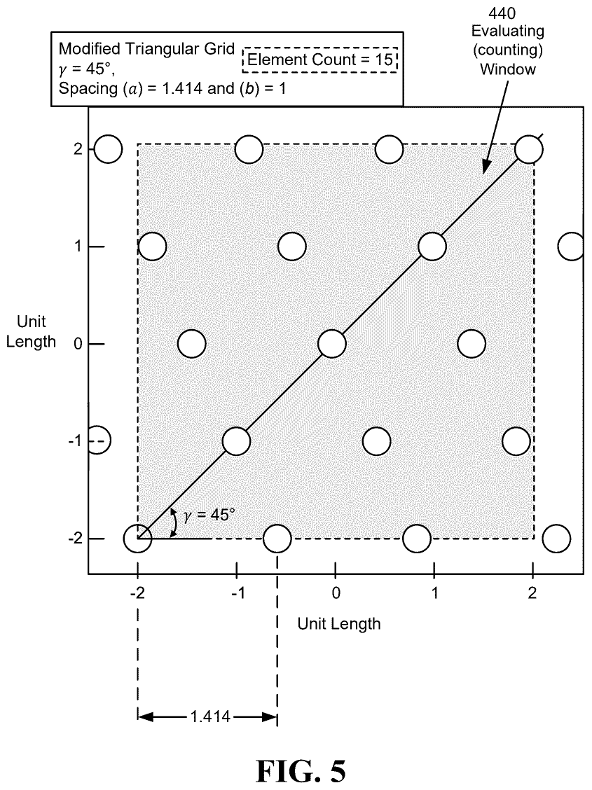

An example application of this method is shown in FIG. 5, with the center locations of the elements (unit cells) calculated using Equations (1) and (12). These are represented as the unshaded circles, and as can be seen, with a unit length of

$$b = \frac{λ}{2} = 1$$

unit length vertical spacing, and θₘₐₓ=90°, the circles are horizontally separated by the distance

$$a = \frac{λ}{2} * \frac{1}{sin ( 45 ° )} ≅ \frac{b}{sin ( 45 ° )} = 1.414$$

unit lengths horizontal spacing.

For comparison, the standard square grid (of shaded, dashed dots) is shown in FIG. 4. With the grid angle being γ=90°, the maximum space a can be calculated using Equation (12). This yields the classical half-wavelength spacing, namely 1.0 unit length for both horizontal and vertical spacing, as shown in FIG. 4.

FIGS. 4 and 5 also show an arbitrary counting (evaluating) window 440 that highlights the increased sparsity based on the modified triangular grid pattern described herein. Inside the evaluating window 440 of a 5×5 unit-length, in the rectangular pattern of FIG. 4, a total of 25 unit-cells are included (the area does not have a physical meaning, and any dots on boundary are defined to be inclusive within the evaluation window). In contrast, in the modified triangular grid pattern of FIG. 5 with a grid angle of γ=45°, the maximum spacing a is 1.414 times the unit-length. The maximum spacing is thus increased by approximately 41% relative to the square grid pattern, whereby the expected reduction in the number of unit-cells is also 41%. Indeed, even with these relatively small numbers of elements and the small evaluation window, in the examples of FIGS. 4 and 5, within the example evaluation window 440 the element count decreases from 25 (FIG. 4) to 15 (FIG. 4), which is a 40% reduction (and only a 1% mismatch compared to the expected sparsity reduction due to the small evaluation window). Significantly, as one unit length is defined as one half-wavelength distance, this spacing surpasses the conventional threshold while avoiding grating lobes.

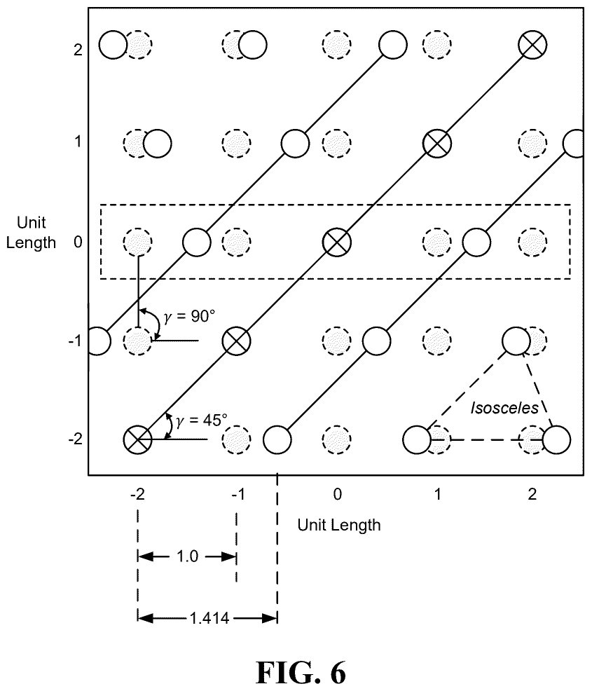

For further visualization, FIG. 6 shows the two grid structures overlaid, with the square grid structure represented by the shaded, dashed circles, and the modified triangular grid structure represented by the unshaded circles; circles with a “crossed-X” pattern are in a common position in both grid structures. As can be seen, with the modified triangular grid structure variation of γ=45°, from which maximum spacing a of approximately 1.414 unit length is derived, versus the conventional square grid structure of γ=90° with the conventional (and derived) maximum spacing b=a of 1.0 unit length, the technology described herein achieves a cost and power reduction by distributing the unit-cells more sparsely (by increasing the spacing distance in one dimension), exceeding the conventional λ/2 spacing while avoiding grating lobes.

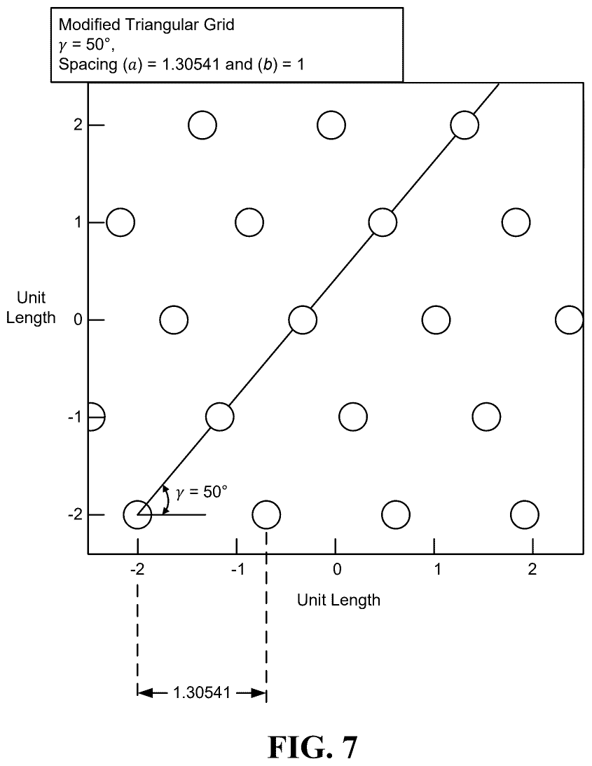

Note that while the grid angle of γ=45° provides significant benefits, the technology described herein is not limited to γ=45°. Indeed, the expressions derived herein for the maximum spacing a in the triangular modified grid structure provides for determining a different γ by finding a balance between achieving a desired (e.g., maximum) reduction in unit-cell count while reducing (e.g., minimizing) gain degradation. For example, FIG. 7 shows a triangular modified grid structure (with a grid angle γ=) 50°, thus having somewhat less sparsity relative to FIG. 5 (γ=45°), but still approximately a 30% unit-cell count reduction relative to FIG. 4 (γ=90°). Note that selecting γ=50° corresponds to a derived maximum spacing a of approximately 1.30541 unit length (again based on a scan angle of θₘₐₓ=) 90°. The positioning for any element can be based on equation (1) to align with the grid angle, e.g., an element directly above and to the right of another element has an x-coordinate offset of x_{offset}=cot 50°≈0.8391 from that other element. For a given reconfigurable intelligent surface application, it may be that such a triangular modified grid structure, such as with a grid angle of γ=50°, achieves a more desirable reduction in unit-cell count with more desirable gain, compared to a square grid structure or other triangular modified grid structures. Specific processes can be used or developed to determine the grid angle γ for a given application.

To summarize, the technology described herein increases the element spacing for any reconfigurable intelligent surface design, providing a periodic structure beyond the half-wavelength threshold. The technology takes into account the need to avoid grating lobes and ensure symmetrical scanning. The spacing is determined by factors including frequency, maximum scan angle, and the grid (arrangement) angle. This facilitates a more extensive spacing between elements, while mitigating the impact on other performance aspects. Increasing the spacing as described herein translates to fewer elements, fewer components, and ultimately reduced costs.

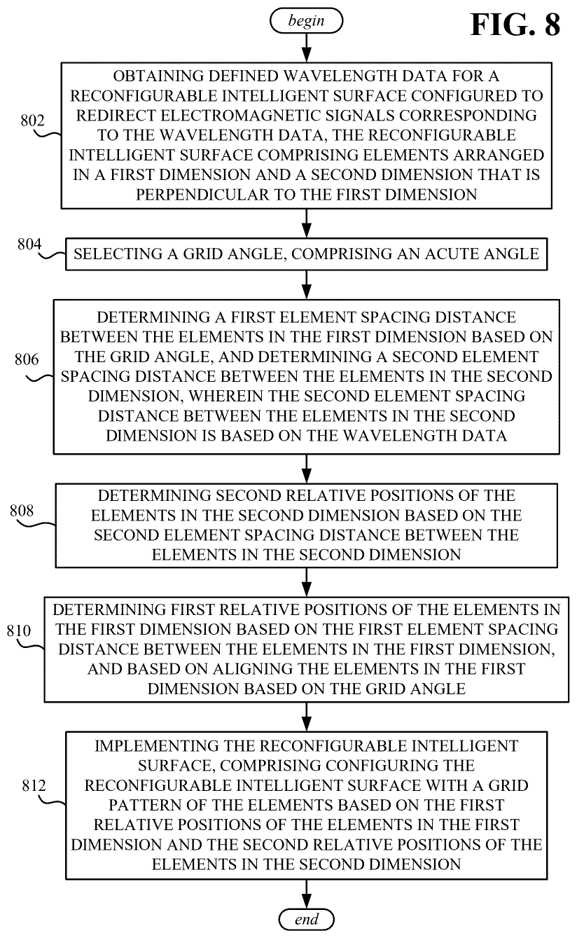

One or more concepts described herein can be embodied in a system, such as represented in the example operations of FIG. 8, and for example can include a memory that stores computer executable components and/or operations, and a processor that executes computer executable components and/or operations stored in the memory. Example operations can include operation 802, which represents obtaining defined wavelength data for a reconfigurable intelligent surface configured to redirect electromagnetic signals corresponding to the wavelength data, the reconfigurable intelligent surface comprising elements arranged in a first dimension and a second dimension that is perpendicular to the first dimension. Example operation 804 represents selecting a grid angle, comprising an acute angle. Example operation 806 represents determining a first element spacing distance between the elements in the first dimension based on the grid angle, and determining a second element spacing distance between the elements in the second dimension, wherein the second element spacing distance between the elements in the second dimension is based on the wavelength data. Example operation 808 represents determining second relative positions of the elements in the second dimension based on the second element spacing distance between the elements in the second dimension. Example operation 810 represents determining first relative positions of the elements in the first dimension based on the first element spacing distance between the elements in the first dimension, and based on aligning the elements in the first dimension based on the grid angle. Example operation 812 represents implementing the reconfigurable intelligent surface, comprising configuring the reconfigurable intelligent surface with a grid pattern of the elements based on the first relative positions of the elements in the first dimension and the second relative positions of the elements in the second dimension.

The first dimension can correspond to a horizontal axis, and wherein the second dimension can correspond to a vertical axis. Determining the first relative positions of the first elements in the first dimension can be based on aligning, along the grid angle, a selected element in one row of the horizontal axis with an adjacent element in a row vertically above and to the right of the selected element.

Selecting the grid angle can include selecting the grid angle based on acceptable specular loss dependent on ground exposure ratio data of a design of the elements. Note that before implementing a reconfigurable intelligent surface as described herein, operations can including verifying that the surface with the initial grid angle has a sufficient ground panel exposure ratio such that the specular reflection effect is minor.

Determining the first element spacing distance can include determining a maximum first element spacing distance between the first elements in the first dimension based on the grid angle and an operating frequency corresponding to the wavelength data to avoid grating-lobe effects, and wherein the determining of the second element spacing distance between the second elements in the second dimension comprises determining a maximum second element spacing distance between the second elements in the second dimension based on the operating frequency. Selecting the grid angle can include selecting a forty-five degree angle.

Selecting the grid angle can include selecting an angle larger than thirty degrees and smaller than sixty degrees.

The first element spacing distance can equal one divided by a sine of the grid angle times the second element spacing distance.

The wavelength data can correspond to a wavelength distance, and wherein the second element spacing distance is one-half of the wavelength distance.

The wavelength data can correspond to a wavelength distance, the reconfigurable intelligent surface can be associated with a maximum elevation angle, and the first element spacing distance can be a function of the wavelength distance, a first sine based on the maximum elevation angle, and a second sine based on the grid angle.

Further operations can include, after the implementing of the reconfigurable intelligent surface, redirecting the electromagnetic signals impinging on the reconfigurable intelligent surface.

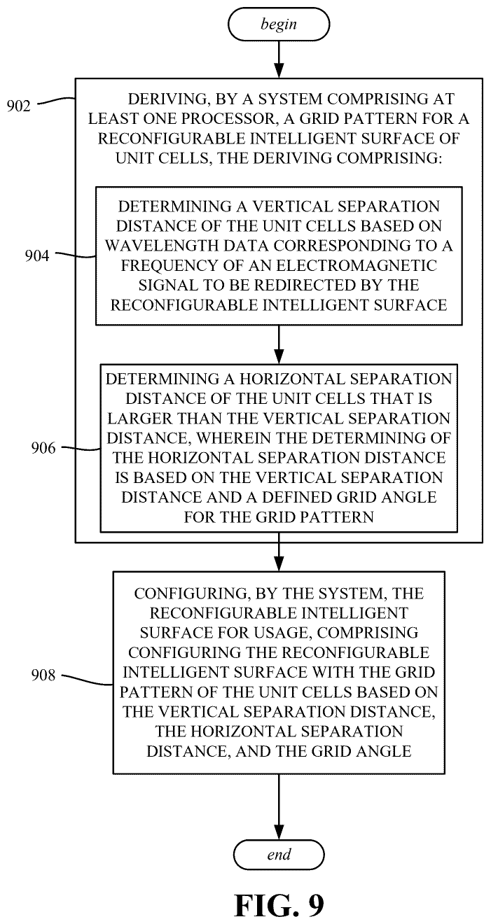

One or more example implementations and embodiments, such as corresponding to example operations of a method, are represented in FIG. 9. Example operation 902 represents deriving, by a system comprising at least one processor, a grid pattern for a reconfigurable intelligent surface of unit cells. The deriving can include operations 904 and 906. Example operation 904 represents determining a vertical separation distance of the unit cells based on wavelength data corresponding to a frequency of an electromagnetic signal to be redirected by the reconfigurable intelligent surface. Example operation 906 represents determining a horizontal separation distance of the unit cells that is larger than the vertical separation distance; determining the horizontal separation distance can be based on the vertical separation distance and a defined grid angle for the grid pattern. Example operation 908 represents configuring, by the system, the reconfigurable intelligent surface for usage, which can include configuring the reconfigurable intelligent surface with the grid pattern of the unit cells based on the vertical separation distance, the horizontal separation distance, and the grid angle.

Deriving the grid pattern can include aligning, along the grid angle, respective elements in respective horizontal rows, with respective adjacent elements in respective horizontal rows vertically above and to the right of the respective elements.

The wavelength data can correspond to a wavelength distance, the vertical spacing distance can include a maximum vertical separation distance of one-half of the wavelength distance, and determining the horizontal separation distance can include determining a maximum horizontal separation distance by dividing the one-half of the wavelength distance by a sine of the grid angle.

The defined grid angle can be forty-five degrees.

The defined grid angle can be greater than thirty degrees and less than sixty degrees.

The wavelength data can correspond to a wavelength distance represented by λ₀, the reconfigurable intelligent surface can be associated with a maximum elevation angle θₘₐₓ, the grid angle can be represented by γ, determining of the first element spacing distance, represented by a, can include determining:

$$a = \frac{{λ}_{0}}{1 + sin {θ}_{m ax}} * \frac{1}{sin γ} .$$

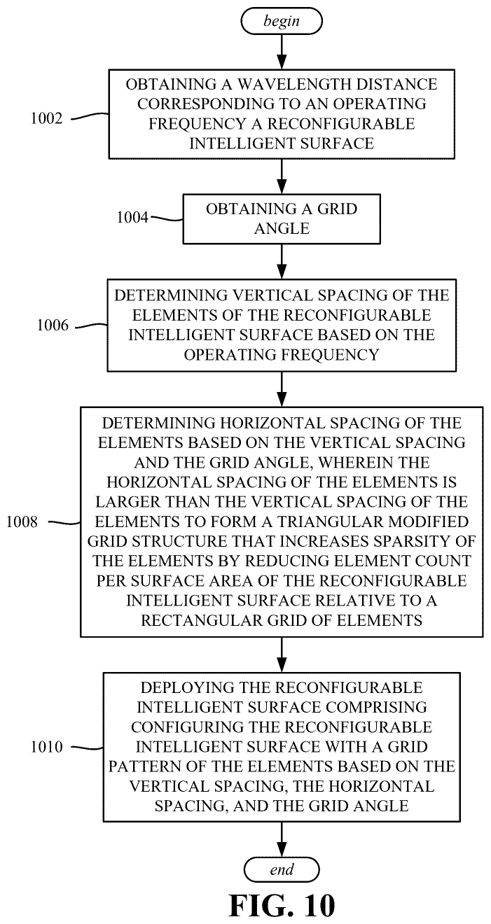

FIG. 10 summarizes various example operations, e.g., corresponding to a machine-readable medium, comprising executable instructions that, when executed by a processor, facilitate performance of operations. Example operation 1002 represents obtaining a wavelength distance corresponding to an operating frequency a reconfigurable intelligent surface. Example operation 1004 obtaining a grid angle. Example operation 1006 represents determining vertical spacing of the elements of the reconfigurable intelligent surface based on the operating frequency. Example operation 1008 represents determining horizontal spacing of the elements based on the vertical spacing and the grid angle, wherein the horizontal spacing of the elements is larger than the vertical spacing of the elements to form a triangular modified grid structure that increases sparsity of the elements by reducing element count per surface area of the reconfigurable intelligent surface relative to a rectangular grid of elements. Example operation 1010 represents deploying the reconfigurable intelligent surface comprising configuring the reconfigurable intelligent surface with a grid pattern of the elements based on the vertical spacing, the horizontal spacing, and the grid angle.

Obtaining the grid angle can include determining the grid angle based on acceptable specular loss dependent on ground exposure ratio data of a design of the elements.

Determining the vertical spacing can include determining a maximum vertical element spacing distance between the elements based on the operating frequency, and determining the horizontal spacing can include determining a maximum horizontal element spacing distance between the elements based on the grid angle and the vertical spacing to avoid grating-lobe effects based on a defined grating-lobe effect avoidance criterion.

As can be seen, the technology described herein facilitates designing and implementing a reconfigurable intelligent surface with a modified triangular grid structure, resulting in a sparser array of elements compared to metasurfaces with rectangular grid structures. This is accomplished without adding complexity to the element design and control (unlike prior technologies). At the same time, the technology described herein avoids the grating lobe in the entire scanning range while achieving symmetrical scanning. Note that based on equation (10), the technology is also extendable to reconfigurable intelligent surfaces with a more limited scanning range. Additionally, the technology described herein can be applied as a supplement to various existing methods and other cost reduction methods and processes, making it highly adaptable in the field of reconfigurable intelligent surfaces.

As described, an example grid angle γ=45° results in a spacing of 1.41 times of the conventional half-wavelength spacing constraint. The corresponding cost reduction, with only a very small loss in gain, is achieved via the modified grid structure. In this instance, the technology described herein achieves a 41% reduction in manufacturing cost and power consumption while avoiding gain degradation, effectively addressing concerns for reconfigurable intelligent surfaces. This level of reduction is not attainable through direct size reduction or by increasing spacing beyond λ/2 in a standard grid structure, where a noticeable reduction in the main lobe gain is expected.

Indeed, the gain reduction and cost reduction (the same percentage cost reduction using both techniques) is summarized in the following table, for one grid structure with element reduction via prior techniques, e.g., a straightforward reduction in panel size, versus the modified triangular grid structure described herein. As can be seen, straightforward reduction in panel size has a gain reduction of 4.54 dBi, a large percentage of the original), versus the modified triangular grid structure (gain reduction of only 1.0 dBi) as described herein:

| Parameter name | Direct Reduction | Modified Grid Structure |
|---|---|---|
| Original Gain (dBi) without | 15.25 dBi | 15.25 dBi |
| reduction | | |
| Cost Reduction (USD, %) | 1565.5 (41%) | 1589.5 (41%) |
| Gain after Reduction (dBi) | 10.71 dBi | 14.25 dBi |

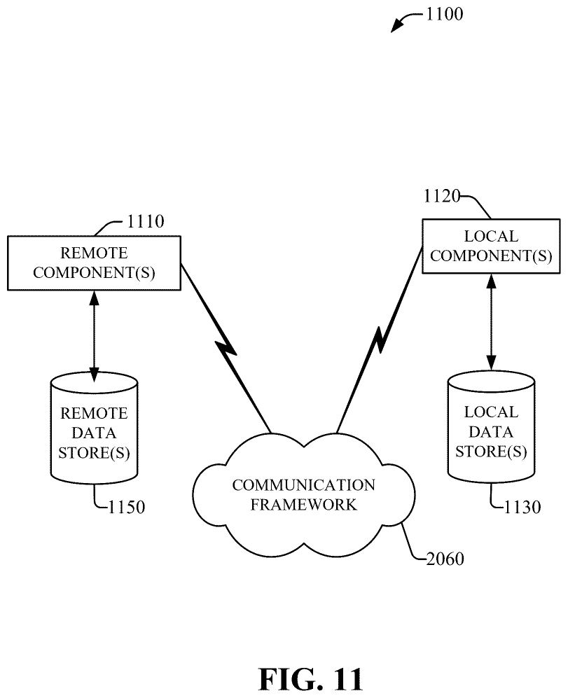

FIG. 11 is a schematic block diagram of a computing environment 1100 with which the disclosed subject matter can interact. The system 1100 comprises one or more remote component(s) 1110. The remote component(s) 1110 can be hardware and/or software (e.g., threads, processes, computing devices). In some embodiments, remote component(s) 1110 can be a distributed computer system, connected to a local automatic scaling component and/or programs that use the resources of a distributed computer system, via communication framework 1140. Communication framework 1140 can comprise wired network devices, wireless network devices, mobile devices, wearable devices, radio access network devices, gateway devices, femtocell devices, servers, etc.

The system 1100 also comprises one or more local component(s) 1120. The local component(s) 1120 can be hardware and/or software (e.g., threads, processes, computing devices). In some embodiments, local component(s) 1120 can comprise an automatic scaling component and/or programs that communicate/use the remote resources 1110, etc., connected to a remotely located distributed computing system via communication framework 1140.

One possible communication between a remote component(s) 1110 and a local component(s) 1120 can be in the form of a data packet adapted to be transmitted between two or more computer processes. Another possible communication between a remote component(s) 1110 and a local component(s) 1120 can be in the form of circuit-switched data adapted to be transmitted between two or more computer processes in radio time slots. The system 1100 comprises a communication framework 1140 that can be employed to facilitate communications between the remote component(s) 1110 and the local component(s) 1120, and can comprise an air interface, e.g., Uu interface of a UMTS network, via a long-term evolution (LTE) network, etc. Remote component(s) 1110 can be operably connected to one or more remote data store(s) 1150, such as a hard drive, solid state drive, SIM card, device memory, etc., that can be employed to store information on the remote component(s) 1110 side of communication framework 1140. Similarly, local component(s) 1120 can be operably connected to one or more local data store(s) 1130, that can be employed to store information on the local component(s) 1120 side of communication framework 1140.

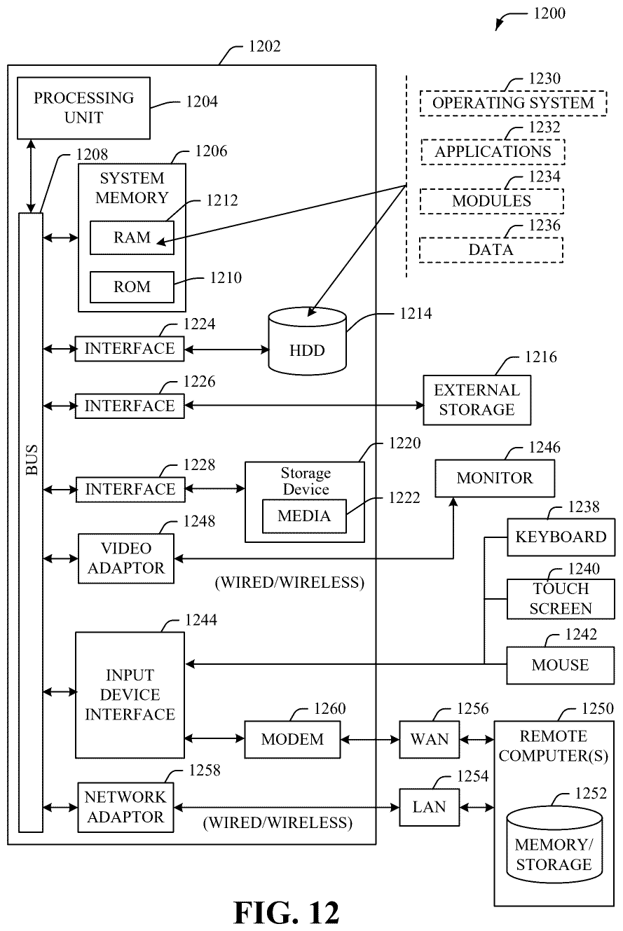

In order to provide additional context for various embodiments described herein, FIG. 12 and the following discussion are intended to provide a brief, general description of a suitable computing environment 1200 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example environment 1200 for implementing various embodiments of the aspects described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), and can include one or more external storage devices 1216 (e.g., a magnetic floppy disk drive (FDD) 1216, a memory stick or flash drive reader, a memory card reader, etc.). While the internal HDD 1214 is illustrated as located within the computer 1202, the internal HDD 1214 can also be configured for external use in a suitable chassis (not shown). Additionally, while not shown in environment 1200, a solid state drive (SSD) could be used in addition to, or in place of, an HDD 1214.

Other internal or external storage can include at least one other storage device 1220 with storage media 1222 (e.g., a solid state storage device, a nonvolatile memory device, and/or an optical disk drive that can read or write from removable media such as a CD-ROM disc, a DVD, a BD, etc.). The external storage 1216 can be facilitated by a network virtual machine. The HDD 1214, external storage device(s) 1216 and storage device (e.g., drive) 1220 can be connected to the system bus 1208 by an HDD interface 1224, an external storage interface 1226 and a drive interface 1228, respectively.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (virtual machine) of multiple virtual machines hosted at computer 1202. Furthermore, operating system 1230 can provide runtime environments, such as the Java runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1294 serial port, a game port, a USB port, an IR interface, a BLUETOOTH® interface, etc.

A monitor 1246 or other type of display device can be also connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are examples and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

As used in this application, the terms “component,” “system,” “platform,” “layer,” “selector,” “interface,” and the like are intended to refer to a computer-related resource or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A system, comprising:
a processor; and
a memory that stores executable instructions that, when executed by the processor, facilitate performance of operations, the operations comprising:
obtaining defined wavelength data for a reconfigurable intelligent surface configured to redirect electromagnetic signals corresponding to the wavelength data, the reconfigurable intelligent surface comprising elements arranged in a first dimension and a second dimension that is perpendicular to the first dimension;
selecting a grid angle, comprising an acute angle;
determining a first element spacing distance between first elements in the first dimension based on the grid angle, and determining a second element spacing distance between second elements in the second dimension, wherein the second element spacing distance between the second elements in the second dimension is based on the wavelength data;
determining second relative positions of the second elements in the second dimension based on the second element spacing distance between the second elements;
determining first relative positions of the first elements in the first dimension based on the first element spacing distance between the first elements in the first dimension, and based on aligning the first elements in the first dimension based on the grid angle; and
implementing the reconfigurable intelligent surface, comprising configuring the reconfigurable intelligent surface with a grid pattern of the elements based on the first relative positions of the first elements in the first dimension and the second relative positions of the second elements in the second dimension.

2. The system of claim 1, wherein the first dimension corresponds to a horizontal axis, and wherein the second dimension corresponds to a vertical axis.

3. The system of claim 2, wherein the determining of the first relative positions of the first elements in the first dimension is based on aligning, along the grid angle, a selected element in one row of the horizontal axis with an adjacent element in a row vertically above and to the right of the selected element.

4. The system of claim 1, wherein the selecting of the grid angle comprises selecting the grid angle based on acceptable specular loss dependent on ground exposure ratio data of a design of the elements.

5. The system of claim 1, wherein the determining of the first element spacing distance comprises determining a maximum first element spacing distance between the first elements in the first dimension based on the grid angle and an operating frequency corresponding to the wavelength data to avoid grating-lobe effects, and wherein the determining of the second element spacing distance between the second elements in the second dimension comprises determining a maximum second element spacing distance between the second elements in the second dimension based on the operating frequency.

6. The system of claim 1, wherein the selecting of the grid angle comprises selecting a forty-five degree angle.

7. The system of claim 1, wherein the selecting of the grid angle comprises selecting an angle larger than thirty degrees and smaller than sixty degrees.

8. The system of claim 1, wherein the first element spacing distance equals one divided by a sine of the grid angle times the second element spacing distance.

9. The system of claim 1, wherein the wavelength data corresponds to a wavelength distance, and wherein the second element spacing distance is one-half of the wavelength distance.

10. The system of claim 1, wherein the wavelength data corresponds to a wavelength distance, wherein the reconfigurable intelligent surface is associated with a maximum elevation angle, and wherein the first element spacing distance is a function of the wavelength distance, a first sine based on the maximum elevation angle, and a second sine based on the grid angle.

11. The system of claim 1, wherein the operations further comprise, after the implementing of the reconfigurable intelligent surface, redirecting the electromagnetic signals impinging on the reconfigurable intelligent surface.

12. A method, comprising:
deriving, by a system comprising at least one processor, a grid pattern for a reconfigurable intelligent surface of unit cells, the deriving comprising:
determining a vertical separation distance of the unit cells based on wavelength data corresponding to a frequency of an electromagnetic signal to be redirected by the reconfigurable intelligent surface; and
determining a horizontal separation distance of the unit cells that is larger than the vertical separation distance, wherein the determining of the horizontal separation distance is based on the vertical separation distance and a defined grid angle for the grid pattern; and
configuring, by the system, the reconfigurable intelligent surface for usage, comprising configuring the reconfigurable intelligent surface with the grid pattern of the unit cells based on the vertical separation distance, the horizontal separation distance, and the grid angle.

13. The method of claim 12, wherein the deriving of the grid pattern comprises aligning, along the grid angle, respective elements in respective horizontal rows, with respective adjacent elements in respective horizontal rows vertically above and to the right of the respective elements.

14. The method of claim 12, wherein the wavelength data corresponds to a wavelength distance, wherein the vertical spacing distance comprises a maximum vertical separation distance of one-half of the wavelength distance, and wherein the determining of the horizontal separation distance comprises determining a maximum horizontal separation distance by dividing the one-half of the wavelength distance by a sine of the grid angle.

15. The method of claim 12, wherein the defined grid angle is forty-five degrees.

16. The method of claim 12, wherein the defined grid angle is greater than thirty degrees and less than sixty degrees.

17. The method of claim 12, wherein the wavelength data corresponds to a wavelength distance represented by λ₀, wherein the reconfigurable intelligent surface is associated with a maximum elevation angle θₘₐₓ, wherein the grid angle is represented by γ, and wherein the determining of the first element spacing distance, represented by a, comprises determining:
$$a = \frac{{λ}_{0}}{1 + sin {θ}_{m ax}} * \frac{1}{sin γ} .$$

18. A non-transitory machine-readable medium, comprising executable instructions that, when executed by at least one processor, facilitate performance of operations, the operations comprising:
obtaining a wavelength distance corresponding to an operating frequency a reconfigurable intelligent surface;
obtaining a grid angle;
determining vertical spacing of the elements of the reconfigurable intelligent surface based on the operating frequency;
determining horizontal spacing of the elements based on the vertical spacing and the grid angle, wherein the horizontal spacing of the elements is larger than the vertical spacing of the elements to form a triangular modified grid structure that increases sparsity of the elements by reducing element count per surface area of the reconfigurable intelligent surface relative to a rectangular grid of elements; and
deploying the reconfigurable intelligent surface comprising configuring the reconfigurable intelligent surface with a grid pattern of the elements based on the vertical spacing, the horizontal spacing, and the grid angle.

19. The non-transitory machine-readable medium of claim 18, wherein the obtaining of the grid angle comprises determining the grid angle based on acceptable specular loss dependent on ground exposure ratio data of a design of the elements.

20. The non-transitory machine-readable medium of claim 18, wherein the determining of the vertical spacing comprises determining a maximum vertical element spacing distance between the elements based on the operating frequency, and wherein the determining of the horizontal spacing comprises determining a maximum horizontal element spacing distance between the elements based on the grid angle and the vertical spacing to avoid grating-lobe effects based on a defined grating-lobe effect avoidance criterion.
